(19) United States
(12) Patent Application Publication
(10) Pub. No.: US 2004/0109081 A1
(43) Pub. Date: Jun. 10, 2004

(54) Auto-focusing device, electronic camera, amd auto-focusing method

(76) Inventor: Hidetoshi Sumi, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/473,567

(22) PCT Filed: Jan. 22, 2003
(86) PCT No.: PCT/JP03/00536

(30) Foreign Application Priority Data
Jan. 24, 2002 (JP) 2002-014931

(51) Int. Cl. H04N 5/232

(52) U.S. Cl. 348/345

(57) ABSTRACT

The CPU (13) continuously moves a focusing lens (2) along an optical axis by supplying a control signal to a motor driver (171a) to start continuously driving a focusing motor (stepping motor) (170a). The CPU (13) calculates an AF evaluation value based on high frequency components contained in an image signal output from a CCD (4) by driving the CCD (4) to operate for exposure with a predetermined period while continuously moving the focusing lens (2) and moves the focusing lens (2) to a position that maximizes the AF evaluation value.

### TECHNICAL FIELD

This invention relates to an auto-focusing device to be used for a camera such as a digital camera, to an electronic camera, and to an auto-focusing method.

### BACKGROUND ART

The contrast detection system is being popularly used for auto-focusing control (AF control) of digital cameras which pick up an image of the object by means of a CCD type or MOS type solid state image pickup device, convert the picked up image into image data, and record the obtained image data. This system is being used widely for cameras including digital video cameras and conventional cameras using a film having a CCD as a distance sensor. With the contrast detection system, the focusing lens is driven to move along the optical axis of the camera intermittently by means of a stepping motor in order to perform exposure operations at a number of positions. An AF evaluation value is calculated for each of the positions based on high frequency components contained in the output signal (image data) of the CCD or the like and the position that maximizes the AF evaluation value is determined to be the focusing position. The focusing lens is moved to that position.

For the actual control operation, as shown in FIG. 8, a rough search operation is performed by moving the focusing lens by a large distance (tens of several steps) at a time in the initial stages of the control operation and the focusing lens is moved from an end of the entire range to be traced by the focusing lens for searching to the opposite end so as to perform exposure operations (and calculate AF evaluation values) and this movement is repeated to define a neighboring area of the AF evaluation value maximizing position (neighboring area of the focusing position). Subsequently, a fine search operation is performed at the defined neighboring area of the AF evaluation value maximizing position by moving the focusing lens by a small distance (1 to several steps) at a time in order to determine the AF evaluation value maximizing position (the focusing position) based on the distribution of AF evaluation values in that area. With this arrangement, the focusing operation can be performed at high speed.

As shown in FIGS. 9 and 10, an AF evaluation cycle includes transfer of the CCD data obtained by the immediately preceding exposure operation, calculation of the AF evaluation value, a move and halt of the focusing lens that takes place simultaneously with the transfer and the calculation and waiting for complete attenuation of the vibration of the focusing lens (the period indicated by W in FIGS. 9 and 10). This cycle is repeated for a number of times and the AF evaluation value maximizing position is determined based on the AF evaluation values obtained from the cycles.

However, with the above described auto-focusing method, the period W of waiting for complete attenuation of the vibration of the focusing lens indispensably takes place each time the focusing lens is stopped in the operation of searching for the AF evaluation value maximizing point. In other words, the operation of obtaining the AF evaluation value is a time consuming one and poses a limit for minimizing the time necessary for an auto-focusing operation.

The time necessary for obtaining an AF evaluation value can be reduced by reducing the period of waiting for complete attenuation of the vibration of the focusing lens after a halt of the focusing lens. On the other hand, however, it is necessary to provide a sufficient period of waiting for complete attenuation of the vibration of the focusing lens because, if the period W of waiting for complete attenuation of the vibration of the focusing lens exceeds the AF evaluation cycle period, the AF evaluation values to be detected come to contain noise components that are attributable to vibrations and degrade the accuracy of detecting the position that brings the object into focus particularly when the drive mechanism of the focusing lens that utilizes the stepping motor as actuator involves a large backlash.

Disclosure of Invention According to an embodiment of the invention, an auto-focusing device comprises:

a focusing lens;

an image pickup unit which photoelectrically converts an image of an object which is obtained by the focusing lens and outputs an image signal;

a first movement control unit which continuously moves the focusing lens along an optical axis;

a first exposure control unit which intermittently drives the image pickup unit to operate for exposures during a continuous movement of the focusing lens by the first movement control unit; and

a first position control unit which calculates evaluation values based on image signals output from the image pickup unit as a result of the exposures by the first exposure control unit and controls the position of the focusing lens based on calculated evaluation values.

According to another embodiment of the invention, an auto-focusing device comprises:

a focusing lens;

an image pickup element which photoelectrically converts an image of an object which is obtained by the focusing lens and outputs an image signal; and

a processor which drives the image pickup element to operate intermittently for exposures, while moving the focusing lens continuously along an optical axis, calculates evaluation values based on image signals output from the image pickup element as a result of the exposures and controls a position of the focusing lens based on calculated evaluation values.

According to another embodiment of the invention, an electronic camera comprises:

an optical system which includes a focusing lens;

an image pickup unit which photoelectrically converts an image of an object which is obtained by the optical system and outputs an image signal;

a first movement control unit which continuously moves the focusing lens along an optical axis of the optical system;

a first exposure control unit which intermittently drives the image pickup unit to operate for exposures during a continuous movement of the focusing lens by the first movement control unit;

a first position control unit which calculates evaluation values based on image signals output from the image pickup unit as a result of the exposures by the first exposure control unit and controls the position of the focusing lens based on calculated evaluation values;

an image pickup command issuing unit; and

an image pickup control unit which drives the image pickup unit to operate for exposure in response to an image pickup command issued by the image pickup command issuing unit and records the image signal output from the image pickup unit in a storing medium.

According to another embodiment of the invention, an electronic camera comprises:

an optical system which includes a focusing lens;

an image pickup unit which photoelectrically converts an image of an object which is obtained by the optical system and outputs an image signal; and

a processor which drives the image pickup element to operate intermittently for exposures, while moving the focusing lens continuously along an optical axis, calculates evaluation values based on image signals output from the image pickup element as a result of an intermittent exposures, controls a position of the focusing lens based on calculated evaluation values, drives the image pickup element to operate for exposure in response to a depression of a shutter button, and records the image signal output from the image pickup element in a storing medium.

According to another embodiment of the invention, an auto-focusing method comprises:

continuously driving a focusing lens included in an optical system along an optical axis of the optical system;

driving an image pickup element arranged behind the optical system to intermittently operate for exposures during a continuous driving of the focusing lens;

calculating evaluation values based on image signals output from the image pickup unit; and

controlling a position of the focusing lens based on calculated evaluation values.

### BRIEF DESCRIPTION OF DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 is a schematic block diagram of a main part of a digital camera that is common to all the embodiments of the invention;

FIG. 2 is a flow chart of an image pickup operation of the first embodiment;

FIG. 3 is a timing chart of the operation of the first embodiment during a rough search period;

FIG. 4 is a timing chart of the auto-focusing control operation of the first embodiment;

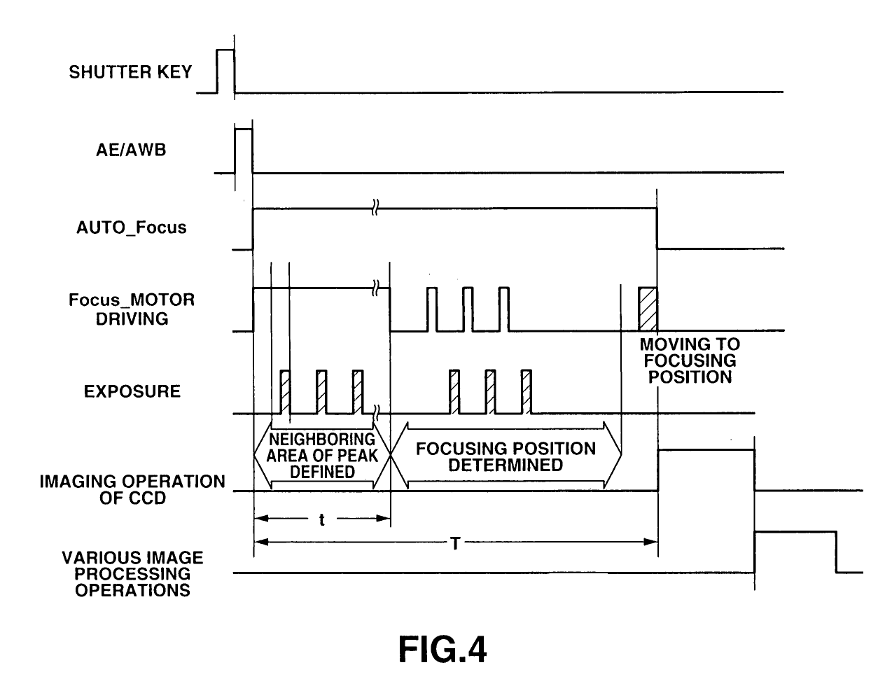

FIG. 5 is a flow chart of an image pickup operation of a second embodiment;

FIG. 6 is a timing chart of the auto-focusing control operation of the second embodiment;

FIG. 7 is a detailed timing chart of the focusing search operation of a third embodiment of the invention;

FIG. 8 is a timing chart of the auto-focusing control operation of a prior art;

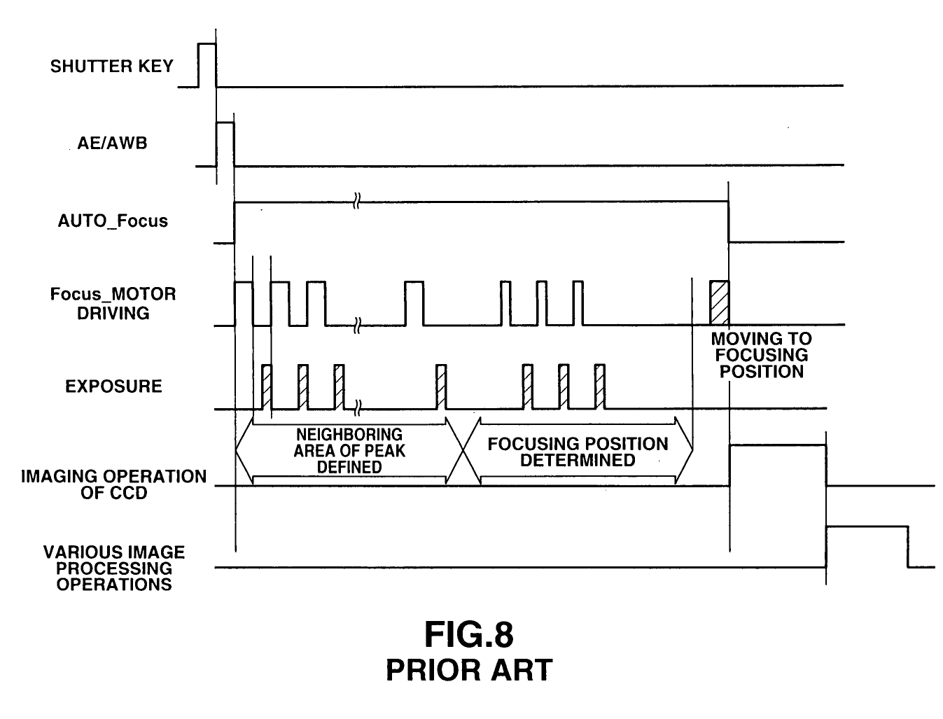

FIG. 9 is a graph illustrating the relationship between the lens position and the AF evaluation value and the operation of a known digital camera during a rough search period; and

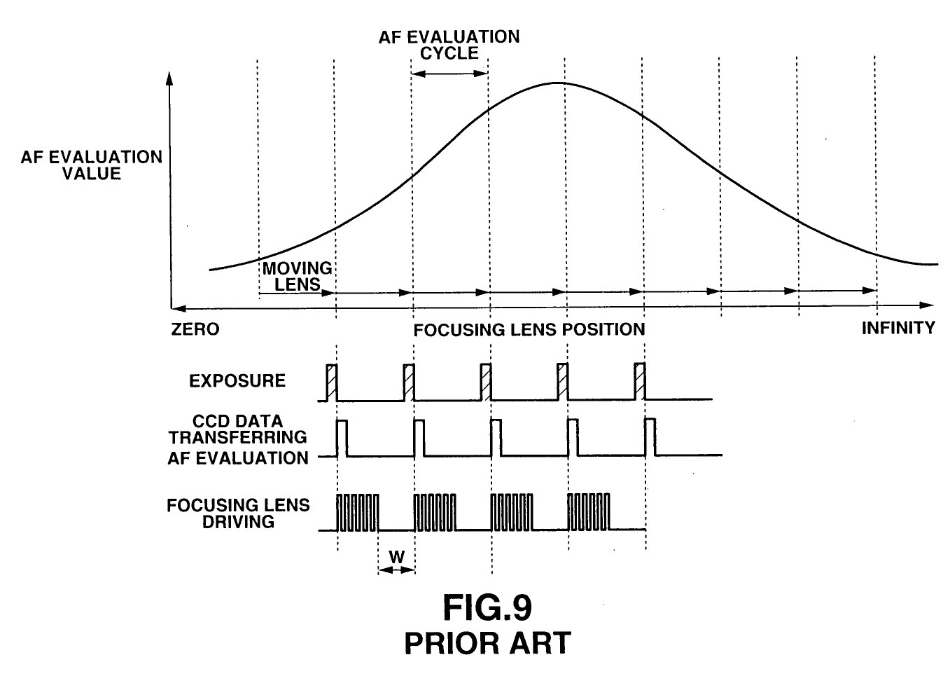

FIG. 10 is a detailed timing chart of the operation of a known digital camera during a rough search period.

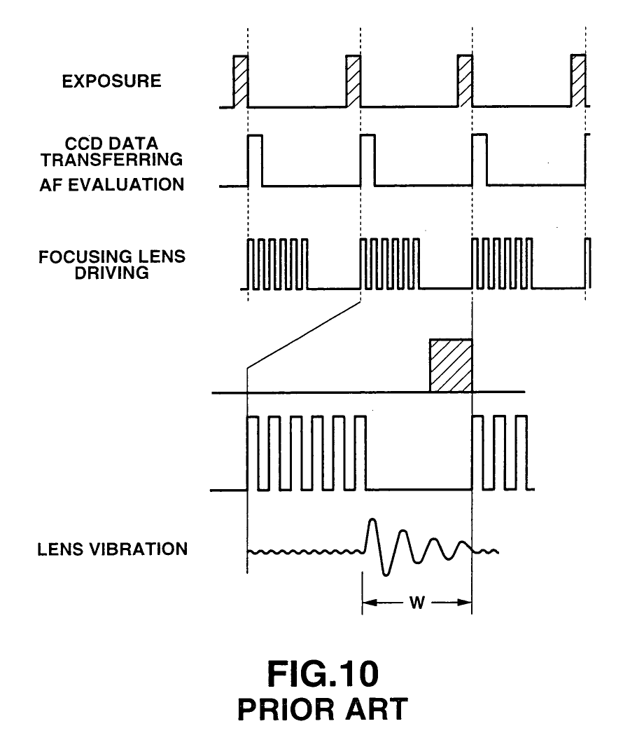

### BEST MODE FOR CARRYING OUT THE INVENTION

The present invention will be described by referring to the accompanying drawings that illustrate preferred embodiments of the invention.

### First Embodiment

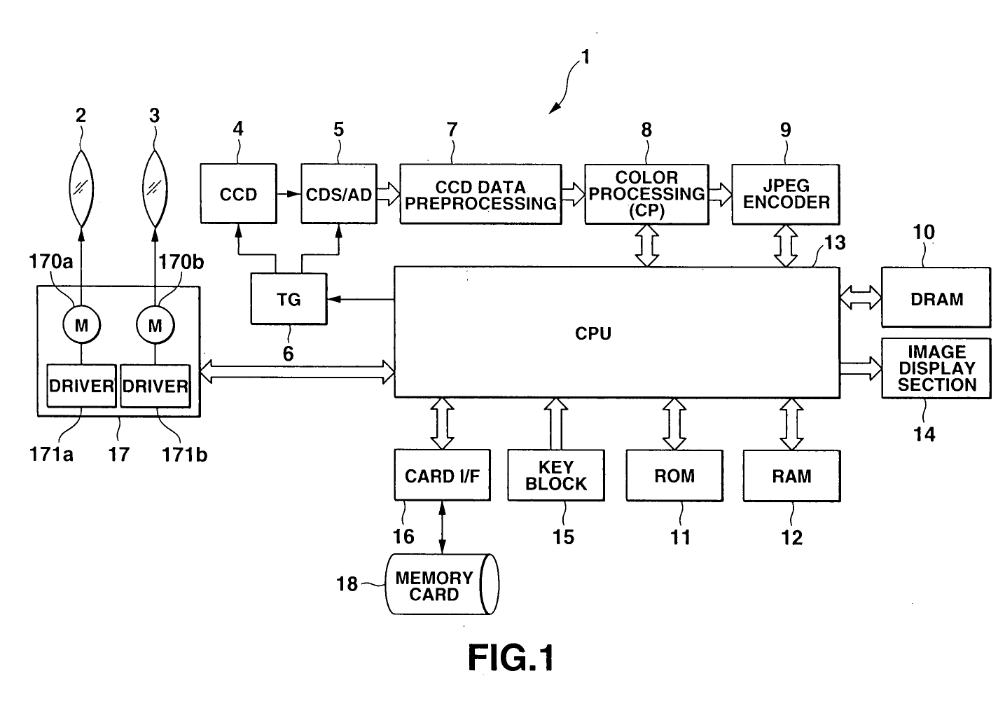

FIG. 1 is a schematic block diagram of a digital camera (electronic camera) 1 that shows a first embodiment of the invention. The digital camera 1 is provided with the AF feature based on the contrast detection system as described above for the prior art. The digital camera 1 comprises a focusing lens 2, a zoom lens 3, a CCD (image pickup means, image pickup device) 4, a CDS/AD block 5, a TG (timing generator) 6, a CCD data preprocessing block 7, a color processing (CP) block 8, a JPEG encoder 9, a DRAM 10, a ROM 11, a RAM 12, a CPU (processor) 13, an image display section 14, a key block 15, a card interface (I/F) 16, and a motor drive block 17. The card interface 16 is connected to a memory card 18 that is removably inserted into a card slot formed in the camera main body.

The focusing lens 2 and the zoom lens 3 are formed by respective groups of lenses (not shown). The motor drive block 17 includes a focusing motor 170a for driving the focusing lens 2 along the optical axis of the camera, a zoom motor 170b for driving the zoom lens 3 also along the optical axis of the camera, and motor drivers 171a, 171b for respectively driving the focusing motor. 170a and the zoom motor 170b according to a control signal supplied from the CPU 13. The focusing motor 170a and the zoom motor 170b are stepping motors that are adapted to accurately drive the focusing lens 2 and the zoom lens 3 stepwise and along the optical axis. In this embodiment, the focusing lens corresponds to the optical system of the camera and the focusing motor 170a and the motor driver 171a are drive means.

The CCD 4 performs an operation of photoelectric conversion on the image of the object irradiated onto the CCD 4 by means of the focusing lens 2 and the zoom lens 3 and outputs an image pickup signal representing the image. The timing generator 6 generates a timing signal of a predetermined frequency to drive the CCD 4. The CDS/AD block 5 removes noises from the output signal of the CCD 4 and converts the image pickup signal into a digital signal. The CCD data preprocessing block 7 performs data processing operations on the image pickup signal that is converted into the digital signal by the CDS/AD block 5. The data processing operations include processing of the luminance signal. The color processing (CP) block 8 performs color processing operations on the image signal that is subjected to processing of the luminance signal by the CCD data preprocessing block 7 to generate Y, Cb, and Cr image data. The DRAM 10 sequentially stores the Y, Cb, and Cr image data obtained as a result of the color processing operations.

The image display section 14 includes a color LCD, a drive circuit for driving the color LCD, and so on. The image display section 14 displays a through image obtained based on the image data of a frame taken by the CCD 4 and stored in the DRAM 10 when the image pickup mode is selected but the shutter key is not depressed yet (imaging standby state). On the other hand, the image display section 14 displays a recorded image obtained based on the image data read out from the memory card 18 and expanded when the reproduction mode is selected. The JPEG encoder 9 compresses the image data supplied from the color processing (CP) block 8 when recording an image. The memory card (recording means, memory) 18 records the compressed image data transmitted via the card interface 16. When reproducing the recorded image, the recorded image data is readout and expanded by the JPEG encoder 9 before the recorded image is displayed in the image display section 14.

The key block 15 includes a switch key for selecting either the image pickup mode or the reproduction mode, a shutter key (key input means capable to be depressed to either of two setting levels, image pickup command input means, shutter button) and other operation keys and transmits an operation signal that corresponds to the key operation at the key block 15 to the CPU 13. The CPU 13 controls the overall operation of the-digital camera 1 according to the operation signal from the key block 15 and a predetermined control program, using the RAM 12 as operation memory. The ROM 11 stores the control program and various data necessary for the CPU 13 to perform various control operations such as AF control, AE control, and AWB control. The CPU 13 functions as the first and second movement control means, the first and second exposure control means, the first and second position control means and the imaging control means as it operates according to the control program.

The control program should not necessarily be stored in the ROM 11. It may alternatively be stored in a predetermined region of the memory card 18. If a programmable memory such as EEPROM is available, it may still alternatively be so arranged that the control program is supplied to the CPU 13 not from the memory card 18 but from the memory into which the control program is written by way of appropriate means such as telecommunication means.

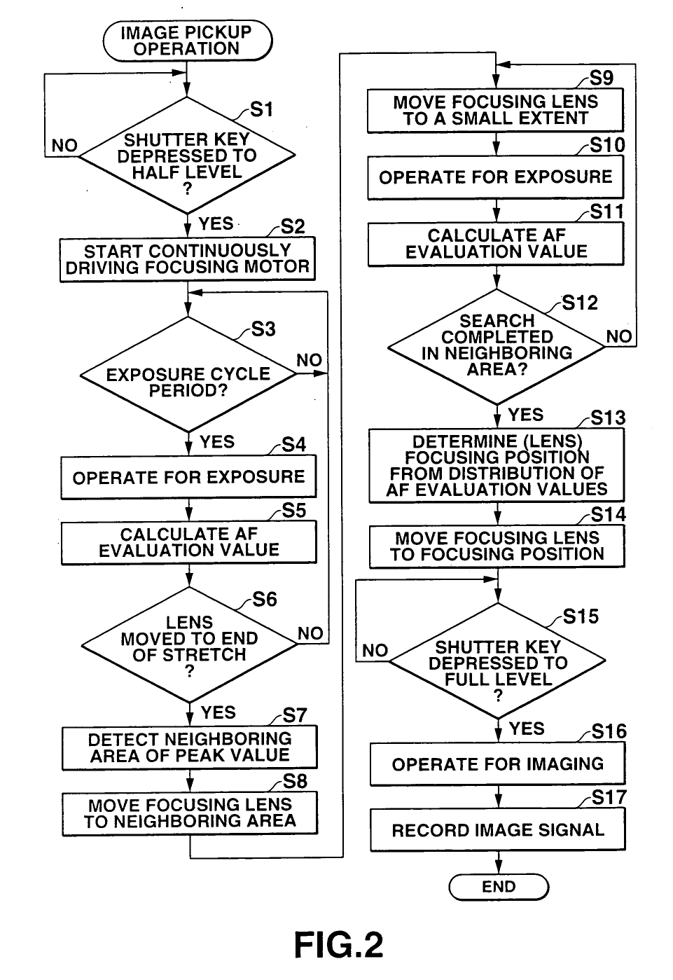

Now the operation of the digital camera 1 having the above described configuration will be described by referring to the flow chart of FIG. 2, illustrating the sequence of the processing operation of the CPU 13 that is performed for an image pickup operation.

The CPU 13 starts the processing operation when the switch key of the key block 15 is operated and the image pickup mode is selected by the user. It determines whether the shutter key is depressed to the half level or not (step S1). If it is determined that the shutter key is depressed to the half level (YES in step S1), it performs a rough search operation in steps S2 through S6.

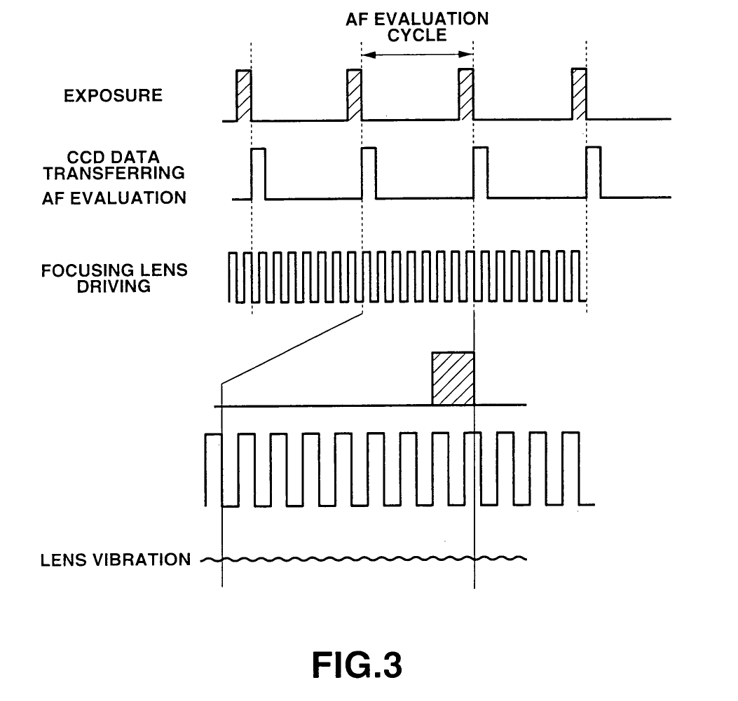

FIG. 3 is a timing chart of the operation of the digital camera 1 during a rough search period. In the rough search period, the CPU 13 starts continuously driving the focusing motor 170a by a large distance at a time (tens of several steps) (step S2). As a result, the focusing lens 2 is continuously driven to move from 5 an end of the focusing search range (e.g., 1 m to ∞) to the other end. If a predetermined very short exposure cycle comes during the movement (step S3), the CPU 13 performs a processing operation of acquiring an image signal that corresponds to the image of the object by driving the CCD 4 for exposure (step S4). A transfer operation of taking in the image signal as CCD data is also performed. Then, the CPU 13 calculates the AF evaluation value based on high frequency components contained in the image signal (step S5). More specifically, the CPU 13 integrates the high frequency components contained in the image signal for a field period and defines the obtained value as the AF evaluation value. It also performs calculations necessary for removing the noise contained in the image signal.

The CPU 13 periodically repeats the above described processing operation for exposure and the calculation of the AF evaluation value (steps S3 through S5) until the focusing lens 2 gets to the end (e.g., ∞) of the focusing search range (NO in step S6). As a result, the CPU 13 calculates a plurality of AF evaluation values for different positions of the focusing lens 2.

When the focusing lens gets to the end (e.g., ∞) of the focusing search range (YES in step S6), the CPU 13 detects the greatest AF evaluation value out of the plurality of AF evaluation values acquired by that time and defines a neighboring area of the AF evaluation value maximizing position (neighboring area of the focusing position) (step S7). Then, the CPU 13 moves the focusing lens 2 to that area (step S8).

Alternatively, the CPU 13 may detect the AF evaluation value maximizing position while carrying out the rough search operation without moving the focusing lens 2 to the end (e.g., ∞) of the focusing search range and stop the movement of the focusing lens 2 when the AF evaluation value maximizing position is detected. More specifically, the CPU 13 may terminate the rough search operation when the AF evaluation value rises at four or more than four consecutive evaluations and then falls at four or more than four consecutive evaluations and move the focusing lens 2 to the position where the AF evaluation value is maximized or a neighboring area of that position.

Then, the CPU 13 performs a fine search operation in steps S9 through S13. The CPU 13 starts driving the focusing lens 2 by a small distance at a time (1 to several steps) in the neighboring area of the AF evaluation value maximizing position by means of the focusing motor 170a (step S9) and then it operates for exposure (step S10) to calculates the AF evaluation value (step S11). The CPU 13 repeats these steps until it calculates all the AF evaluation values in that area (NO in step S12). In other words, the CPU 13 drives the focusing lens 2 intermittently and repeats the operation of acquiring an AF evaluation value each time the focusing lens 2 stops. When all the AF evaluation values are calculated in the area (YES in step S12), it determines the AF evaluation value maximizing position (focusing position) from the distribution of AF evaluation values in the neighboring area (step S13) and moves the focusing lens 2 to the determined position (step S14). Thus, the AF control operation is completed.

As in the rough search operation, the CPU 13 may detect the AF evaluation value maximizing position while carrying out the fine search operation without acquiring all the AF evaluation values in the neighboring area of the AF evaluation value maximizing position and stop the movement of the focusing lens 2 when the AF evaluation value maximizing position is detected. More specifically, the CPU 13 may terminate the fine search operation when the AF evaluation value rises at four or more than four consecutive evaluations and then falls at four or more than four consecutive evaluations and move the focusing lens 2 to the position where the AF evaluation value is maximized.

When the shutter key is depressed to the full level by the user (YES in step S15), the CPU 13 receives the image signal of the object picked up by the camera (step S16) and records the image data of the picked up image in the memory card 18 (step S17) to terminate the image pickup operation.

This embodiment operates for exposure by the CCD 4 while the CPU 13 is continuously driving the focusing lens 2 to move in the above described rough search operation (steps S2 through S6). Therefore, the vibration of the focusing lens 2 is not increased immediately before each exposure operation as seen from FIG. 3. Thus, it is not necessary to provide a period W of waiting for complete attenuation of the vibration of the focusing lens in each AF evaluation cycle for acquiring an AF evaluation value as described above by referring to the prior art. Hence, the AF evaluation cycle can be reduced to the above described time period necessary for an exposure operation (e.g., about 33.3 ms). As a result, the rough research period t that has to be spent for the purpose of defining a neighboring area of the AF evaluation value maximizing position in an AF control period can be reduced to consequently reduce the duration of the AF control period. Thus, an auto-focusing operation can be carried out at high speed.

Additionally, since the vibration of the focusing lens 2 is not increased in each AF evaluation cycle, the vibration frequency that appears in the focusing lens 2 can be reduced to a level lower than the resonance frequency of the focusing motor 170a. Therefore, the sound of the focusing lens 2 and other components generated during the rough search operation can be reduced.

Since the fine search operation for defining a neighboring area of the AF evaluation value maximizing position is performed after a rough search operation, the AF control operation can be carried out at high speed without degrading the accuracy of the ultimate auto-focusing control operation.

The operation of this embodiment can be realized simply by modifying the control program of the CPU 13 without altering the mechanical configuration of the digital camera 1. Therefore, the auto-focusing method according to the present embodiment can be used in any existing digital camera if it is possible to modify the control program of the camera relating to AF control.

While this embodiment is adapted to perform the auto-focusing control operation by means of the control program (software) of the CPU 13, it may alternatively be provided with an electronic circuit (hardware) that can perform the auto-focusing control operation.

Other embodiments of the present invention will be described. The same portions as those of the first embodiment will be indicated in the same reference numerals and their detailed description will be omitted.

### Second Embodiment

If the performance of the optical system including the focusing lens 2 and the zoom lens 3 is such that the object can be brought into focus even when the focusing lens 2 is slightly displaced from the correct focusing position and/or that the vibration of the focusing lens 2 can be held to a low level during its movement and hence the influence of noise on the AF evaluation value due to the vibration can be minimized or eliminated when determining the AF evaluation value, the AF control operation can be performed without the above described fine search operation. Thus, auto-focusing can be realized by conducting a rough search operation, which is substantially same as the above described one, to minimize the AF evaluation cycle (exposure time), detecting the AF evaluation value maximizing position while continuously moving the focusing lens 2 and moving the focusing lens 2 to that focusing position for bringing the object of camera shooting into focus.

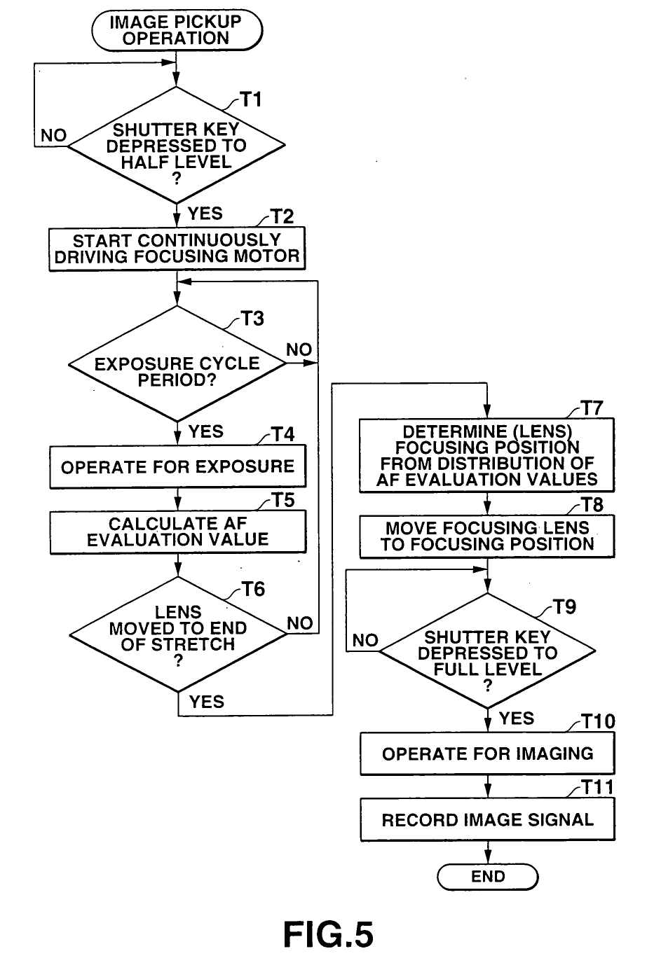

Such an auto-focusing control operation will be described by referring to FIG. 5 that shows a flow chart of the processing operation of the CPU 13 according to a second embodiment.

The CPU 13 starts the processing operation when the switch key of the key block 15 is operated and the image pickup mode is selected by the user. Then, it determines whether the shutter key is depressed to the half level or not (step T1). If it is determined that the shutter key is depressed to the half level (YES in step T1), it performs a search operation for detecting the position of the focusing lens that brings the object of camera shooting into focus in steps T2 through T6. In the search operation, the CPU 13 starts continuously driving the focusing motor 170a (step T2). As a result, the focusing lens 2 is continuously driven to move from an end of the focusing search range (e.g., 1 m to ∞) to the other end. If a predetermined very short exposure cycle comes during the movement (step T3), the CPU 13 performs a processing operation of acquiring an image signal that corresponds to the image of the object by driving the CCD 4 for exposure (step T4). A transfer operation of taking in the image signal as CCD data is also performed. Then, the CPU 13 calculates the AF evaluation value based on the high frequency components contained in the image signal (step T5). More specifically, the CPU 13 integrates the high frequency components contained in the image signal for a field period and defines the obtained value as the AF evaluation value. It also performs calculations necessary for removing the noise contained in the image signal.

The CPU 13 periodically repeats the above described processing operation for exposure and the calculation of the AF evaluation value (steps ST3 through T5) until the focusing lens gets to the end (e.g., ∞) of the focusing search range (NO in step T6). As a result, the CPU 13 calculates a plurality of AF evaluation values for different positions of the focusing lens 2.

When the focusing lens gets to the end (e.g., ∞) of the focusing search range (YES in step T6), the CPU 13 detects the greatest AF evaluation value out of the plurality of AF evaluation values acquired by that time and determines the AF evaluation value maximizing position (the focusing position) based on the distribution of AF evaluation values (step T7). Then, the CPU 13 moves the focusing lens 2 to the determined position (step T8). Alternatively, the CPU 13 may detect the AF evaluation value maximizing position while carrying out the focusing search operation without moving the focusing lens to the end (e.g., ∞) of the focusing search range and stop the movement of the focusing lens 2 when the AF evaluation value maximizing position is detected. More specifically, the CPU 13 may terminate the focusing search operation when the AF evaluation value rises at four or more than four consecutive evaluations and then falls at four or more than four consecutive evaluations and move the focusing lens 2 to the position where the greatest AF evaluation value is calculated.

When the shutter key is depressed to the full level by the user (YES in step T9), the CPU 13 takes in the image signal of the image of the object picked up by the camera (step T10) and records the image data of the picked up image of the object in the memory card 18 (step T11) to terminate the image pickup operation.

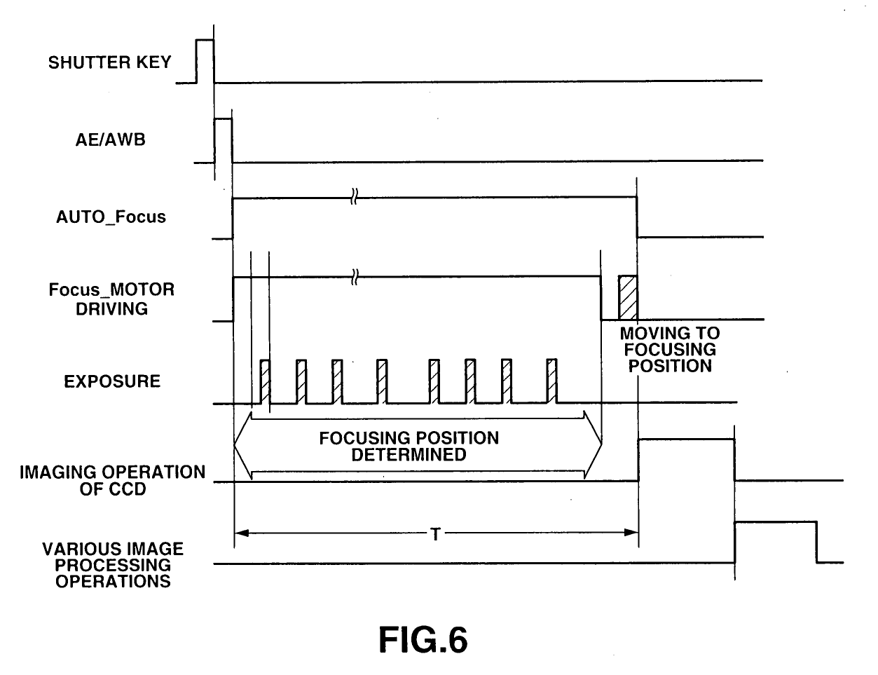

Since the focusing search period t of this embodiment is reduced as shown in FIG. 6, an auto-focusing operation can be carried out at high speed.

The operation of this embodiment can be realized simply by modifying the control program of the CPU 13 without altering the mechanical configuration of the digital camera 1. Therefore, the auto-focusing method according to the present invention can be used in any existing digital camera if it is possible to modify the control program of the camera relating to AF control.

While this embodiment is adapted to do the auto-focusing control operation by means of the control program (software) of the CPU 13, it may alternatively be provided with an electronic circuit (hardware) that can perform the auto-focusing control operation.

### Third Embodiment

In the third embodiment, the CPU 13 performs the processing operation for exposure in step S4 (T4) at the timing as described below in the rough search operation in steps S2 through S6 described above by referring to FIG. 2 for the first embodiment or in the focusing search operation in steps T2 through T6 described above by referring to FIG. 5 for the second embodiment.

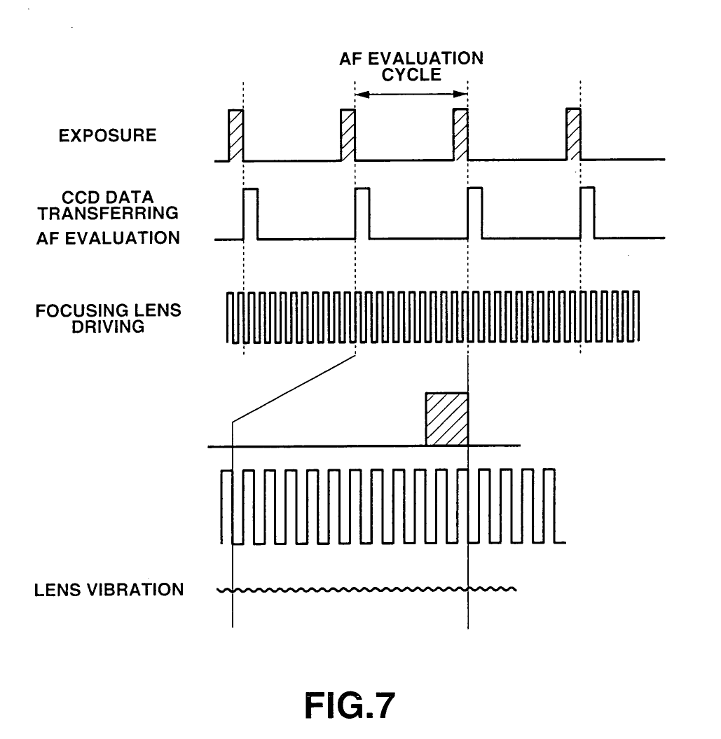

FIG. 7 is a detailed timing chart of the auto-focusing control operation of the third embodiment that corresponds to FIG. 3. For the rough search (focusing search) operation of the third embodiment, the exposure operation of the CCD 4 is performed in synchronism with the drive cycle (drive pulse) of the focusing lens 2 in such a way that the timing of the start of the AF evaluation cycle and that of driving the focusing lens 2 by means of the focusing motor 170a always agree with each other. The exposure operation is performed in such a way that the operation of driving the focusing lens 2 and the exposure operation of the CCD 4 show a constant temporal relationship, although they are performed with different cycles. In other words, the focusing lens 2 is driven to move at a speed that makes the operation of driving the focusing lens 2 and the exposure operation of the CCD 4 show a constant temporal relationship. Otherwise, the operation of the third embodiment is same as that of the first or second embodiment.

In the above described embodiments of the invention, the accuracy of the rough search operation (focusing search operation) is improved because the noise that is caused by the vibration generated while the focusing lens 2 is moving to influence the AF evaluation value becomes constant for each AF evaluation cycle. Thus, in the first embodiment, the auto-focusing operation can be performed at higher speed by narrowing the neighboring area of the AF evaluation value maximizing position where a fine search operation is performed after a rough search operation and hence the time T necessary for an AF control operation.

While the present invention is described in terms of a digital camera, the present invention can be applied to other cameras that utilize a CCD or some other image pickup element as sensor and are adapted to perform AF control operations by using the contrast detection system to provide similar advantages.

### Industrial Applicability

This invention provides an auto-focusing device to be used for a camera such as a digital camera, an electronic camera, and an auto-focusing method.

1. An auto-focusing device comprising:
a focusing lens;
an image pickup unit which photoelectrically converts an image of an object which is obtained by the focusing lens and outputs an image signal;
a first movement control unit which continuously moves the focusing lens along an optical axis;
a first exposure control unit which intermittently drives the image pickup unit to operate for exposures during a continuous movement of the focusing lens by the first movement control unit; and
a first position control unit which calculates evaluation values based on image signals output from the image pickup unit as a result of the exposures by the first exposure control unit and controls the position of the focusing lens based on calculated evaluation values.

2. The device according to claim 1, wherein
the first position control unit moves the focusing lens to a neighboring area of a focusing position based on the evaluation values; and further comprising:
a second movement control unit which intermittently moves the focusing lens along the optical axis in the neighboring area of the focusing position;
a second exposure control unit which drives the image pickup unit to operate for exposures at timings of stopping of an intermittent movement of the focusing lens caused by the second movement control unit; and
a second position control unit which calculates evaluation values based on image signals output from the image pickup unit as a result of the exposures by the second exposure control unit and moves the focusing lens to the focusing position based on the evaluation values.

3. The device according to claim 1, wherein the first position control unit moves the focusing lens to the focusing position based on the calculated evaluation values.

4. The device according to claim 1, wherein
the first movement control unit comprises a drive unit which moves the focusing lens and a control unit which periodically drives the drive unit; and
the first exposure control unit drives the image pickup unit to operate for exposures with a predetermined cycle period in synchronism with a periodic driving timing of the drive unit.

5. The device according to claim 1, further comprising:
a key input unit which is adapted to be depressed to either of two levels; and wherein
the first movement control unit starts a continuous movement of the focusing lens when the key input unit is depressed to one of the two levels.

6. The device according to claim 1, further comprising:
an image pickup command issuing unit; and
an image pickup control unit which drives the image pickup unit to operate for exposure in response to an image pickup command issued by the image pickup command issuing unit and records the image signal output from the image pickup unit in a storing medium.

7. The device according to claim 1, wherein the first movement control unit comprises a stepping motor which stepwise drives the focusing lens.

8. An auto-focusing device comprising:
a focusing lens;
an image pickup element which photoelectrically converts an image of an object which is obtained by the focusing lens and outputs an image signal; and
a processor which drives the image pickup element to operate intermittently for exposures, while moving the focusing lens continuously along an optical axis, calculates evaluation values based on image signals output from the image pickup element as a result of the exposures and controls a position of the focusing lens based on calculated evaluation values.

9. The device according to claim 8, wherein the processor moves the focusing lens to a neighboring area of a focusing position based on the evaluation values, subsequently and intermittently moves the focusing lens along the optical axis in the neighboring area of the focusing position, drives the image pickup element to operate for exposures at timings of stopping of an intermittent movement of the focusing lens, calculates evaluation values based on image signals output from the image pickup element as a result of the exposures at the timings of stopping of the intermittent movement of the focusing lens and moves the focusing lens to the focusing position based on calculated evaluation values.

10. The device according to claim 8, wherein the processor moves the focusing lens to the focusing position based on the calculated evaluation values.

11. The device according to claim 8, further comprising a focusing motor which moves the focusing lens and wherein the processor comprises a control unit which periodically drives the focusing motor and the processor drives the image pickup element to operate for exposures with a predetermined cycle period in synchronism with a periodic driving timing of the focusing motor.

12. The device according to claim 8, further comprising:
a shutter button which is adapted to be depressed to either of two levels; and wherein
the processor starts a continuous movement of the focusing lens when the shutter button is depressed to one of the two levels.

13. The device according to claim 12, wherein the processor drives the image pickup element to operate for exposures when the shutter button is depressed to another one of the two levels and records the image signal output from the image pickup element in a storing medium.

14. The device according to claim 8, further comprising a stepping motor which moves the focusing lens and wherein the processor comprises a control unit which continuously moves the focusing lens along an optical axis by driving the stepping motor.

15. An electronic camera comprising:
an optical system which includes a focusing lens;
an image pickup unit which photoelectrically converts an image of an object which is obtained by the optical system and outputs an image signal;
a first movement control unit which continuously moves the focusing lens along an optical axis of the optical system;
a first exposure control unit which intermittently drives the image pickup unit to operate for exposures during a continuous movement of the focusing lens by the first movement control unit;
a first position control unit which calculates evaluation values based on image signals output from the image pickup unit as a result of the exposures by the first exposure control unit and controls the position of the focusing lens based on calculated evaluation values;
an image pickup command issuing unit; and
an image pickup control unit which drives the image pickup unit to operate for exposure in response to an image pickup command issued by the image pickup command issuing unit and records the image signal output from the image pickup unit in a storing medium.

16. An electronic camera comprising:
an optical system which includes a focusing lens;
an image pickup unit which photoelectrically converts an image of an object which is obtained by the optical system and outputs an image signal; and
a processor which drives the image pickup element to operate intermittently for exposures, while moving the focusing lens continuously along an optical axis, calculates evaluation values based on image signals output from the image pickup element as a result of an intermittent exposures, controls a position of the focusing lens based on calculated evaluation values, drives the image pickup element to operate for exposure in response to a depression of a shutter button, and records the image signal output from the image pickup element in a storing medium.

17. An auto-focusing method comprising:
continuously driving a focusing lens included in an optical system along an optical axis of the optical system;
driving an image pickup element arranged behind the optical system to intermittently operate for exposures during a continuous driving of the focusing lens;
calculating evaluation values based on image signals output from the image pickup unit; and
controlling a position of the focusing lens based on calculated evaluation values.

18. The method according to claim 17, wherein the controlling comprises moving the focusing lens to a neighboring area of a focusing position based on the calculated evaluation values; and further comprising:
intermittently moving the focusing lens along the optical axis in the neighboring area of the focusing position;
driving the image pickup element to operate for exposures at timings of stopping of an intermittent movement of the focusing lens; and
calculating evaluation values based on image signals output from the image pickup unit as a result of the exposures at timings of stopping of the intermittent movement of the focusing lens and moves the focusing lens to the focusing position based on calculated evaluation values.

19. The method according to claim 17, wherein the controlling comprises moving the focusing lens to a focusing position based on the calculated evaluation values.

20. The method according to claim 17, wherein
the continuously driving comprising periodically driving a focusing motor which moves the focusing lens along the optical axis; and
driving the image pickup element comprising causing the image pickup element to operate for exposures with a predetermined cycle period in synchronism with a periodic driving timing of the focusing motor.

21. The method according to claim 17, wherein the continuously driving comprising starting a continuous movement of the focusing lens when a shutter button which is adapted to be depressed to either of two levels is depressed to one of the two levels.
